(19) United States
(12) Patent Application Publication
(10) Pub. No.: US 2015/0382305 A1
(43) Pub. Date: Dec. 31, 2015

(54) SILENT MODE FOR SUBMERGED DEVICES

(71) Applicant: Samir Drincic, Lund (SE)

(72) Inventor: Samir Drincic, Lund (SE)

(73) Assignee: Sony Corporation, Tokyo (JP)

(21) Appl. No.: 14/317,658

(22) Filed: Jun. 27, 2014

(51) Int. Cl. H04W 52/02

(52) U.S. Cl. CPC H04W 52/0251

(57) ABSTRACT

Aspects described herein relate to communication settings in wireless devices and in particular, to communication settings in waterproof wireless devices. Aspects described herein also relate to a method and device for handling communication settings in a waterproof wireless device. According to one aspect, the disclosure relates to a method, performed in a wireless device including communication circuitry for wireless communication, of reducing power consumption. The method includes the steps of detecting that at least a part of the wireless device is submerged in water and reducing power supplied to the communication circuitry based on the detection. Aspects described herein further relate to a wireless device for implementing the method and a corresponding computer program.

### TECHNICAL FIELD

The proposed technology relates to communication settings in wireless devices and in particular it relates to communication settings in waterproof wireless devices. The proposed technology also relates to a method and device for handling communication settings in a waterproof wireless device.

### BACKGROUND

Today many people have a smartphone and an upcoming trend is to connect the smartphone with some kind of wearable, for example a wristband or glasses. There are several different models of wearable devices available and many of them can e.g. be used as a pedometer, a watch or to present status updates from the connected smartphone.

Another trend is that wireless devices such as smartphones and wearables are made waterproof. Such waterproof devices are classified using an International Protection, IP, Code specified in standard 60529 of the International Electrotechnical Commission, IEC. For example, Sony Xperia Z2, is classified as an IP58 phone, where the “5” indicates that ingress of dust is not entirely prevented, but it must not enter in sufficient quantity to interfere with the satisfactory operation of the equipment and number “8” indicates that the phone may be immersed beyond 1 m in depth and the equipment is suitable for continuous immersion in water under conditions which is specified by the manufacturer. The first number, which in other words represents the phones ability to keep particles out, ranges from 1 to 6 and the second number, which indicates the level of protection that the enclosure provides against harmful ingress of water, ranges from 1 to 9. Levels 7, 8 and 9 are indications that a device is waterproof. Level 7 means that a device can be immersed at depth of at most 1 m measured at bottom of device, and at least 15 cm measured at top of device for 30 minutes. Level 9 means that a device is protected against close-range high pressure, high temperature spray downs.

It is a constant goal of manufacturers to produce smartphones and wearables with as long battery time as possible. At the same time, the devices are made as small as possible so that the space allocated for a battery is limited. Thus there is always the need to make devices as energy efficient as possible.

In the case of waterproof smartphones and wearable devices the need to minimize power consumption might be even larger since the casing that ensures that the device is waterproof is often more robust and takes up more space than a regular casing, thus the space reserved for a battery might be even more limited than that of a regular device.

In other words, there is a need to improve the battery time for smartphones and wearables.

### SUMMARY

An aspect of the present disclosure is to provide methods and wireless devices which seek to mitigate, alleviate, or eliminate one or more of the above-identified deficiencies in the art and disadvantages singly or in any combination and to provide a solution wherein the battery time is improved in waterproof wireless devices. The present disclosure proposes a method and device for changing communication settings.

More specifically, the invention proposes a method and device for shutting of all radio communication of a wireless device when the device is submerged in water.

The present disclosure is defined by the appended claims. Various advantageous embodiments of the disclosure are set forth by the appended claims as well as by the following description and the accompanying drawings.

According to some aspects of the disclosure, it provides for a method, performed in a wireless device, comprising communication circuitry for wireless communication, of reducing power consumption.

According to some aspects of the disclosure, the method further comprises the steps of detecting that at least a part of the wireless device is submerged in water and reducing power supplied to the communication circuitry based on the detection. In other words, when detecting that the wireless device is submerged in water, a situation where wireless communication using radio does not work, the power to the communication circuitry is reduced or even turned off.

According to some aspects of the disclosure, the method further comprises the step of detecting that the signal strength of a wireless communication signal is below a predetermined level. When a wireless device is submerged in water all wireless communication signals are lost. This is used as a good indication that the wireless device is submerged.

According to some aspects of the disclosure, the step of detecting that the signal strength of a wireless communication signal is below a predetermined level further comprises determining that the wireless communication signal is below a predetermined level for a predetermined amount of time. An advantage of this is that if a wireless device is for example just dropped in water and then picked up right away, the power supplied to the communication circuitry does not need to be reduced. Another example is when a user of the wireless device just washes the device quickly in water; then the communication circuitry may stay active.

According to some aspects of the disclosure, the wireless communication signal comprises any of, or several of: a GPS signal, a network signal, a WiFi signal, a Bluetooth signal. In other words, the wireless communication signals are radio signals. The network signal is for example a 3rd Generation Partnership Program Long Term Evolution, 3GPP LTE, Wideband Code Division Multiple Access, WCDMA, Worldwide Interoperability for Microwave Access, WiMax, Global System for Mobile Communications, GSM or Universal Mobile Telecommunications System, UMTS, signal.

According to some aspects of the disclosure, the method further comprises the steps of determining that the wireless device is no longer submerged in water and increasing power supplied to the communication circuitry based on the determination. In other words, when the wireless device has determined that it is no longer submerged in water it activates the communication circuitry.

According to some aspects of the disclosure, the step of reducing power supplied to the communication circuitry comprises at least one of: disabling transmission of signals and/or disabling reception of signals. Thus, the communication circuitry is disabled.

According to some aspects of the disclosure, the wireless device further comprises a capacitive touch screen and wherein the step of detecting that the wireless device is submerged in water further comprises detecting that the touch screen is saturated. When a touch screen is saturated it can be assumed that the whole screen is covered or submerged in water, or another liquid with suitable conductivity, no other method of touching or pressing of the screen gives a fully saturated result.

According to some aspects of the disclosure, the step of determining that the wireless device is no longer submerged in water further comprises periodically activating and deactivating the touch screen to determine whether the wireless device is submerged in water. This is an effective way of checking that the wireless device is still submerged in water without activating the communication circuitry.

According to some aspects of the disclosure, the wireless device further comprises at least one water sensor positioned on the outer surface of the wireless device and wherein the step of detecting that the wireless device is submerged in water further comprises detecting, using the water sensor, that water is present. In other words, the wireless device may use water sensors instead of a touch screen to detect submersion. This is especially useful when the wireless device is a wearable without a touch screen.

According to some aspects of the disclosure, the wireless device is a wearable wireless device or a mobile communication device.

According to some aspects of the disclosure, it provides for a wireless device comprising communication circuitry for wireless communication, a power source for supplying power to the communication circuitry and processing circuitry. The processing circuitry is configured to detect that the wireless device is submerged in water; and to reduce power supplied to the communication circuitry based on the detection. In other words, a wireless device is provided which performs the method according to above.

According to some aspects of the disclosure, the processing circuit is further configured to detect that the signal strength of a wireless communication signal is below a predetermined level.

According to some aspects of the disclosure, the processing circuit is further configured to determine that the wireless device is no longer submerged in water and to increase power supplied to the communication circuitry based on the determination.

According to some aspects of the disclosure, the communication circuitry comprises radio communication circuitry. In other words, the wireless device comprises communication circuitry for communication using a GPS signal, a network signal, a WiFi signal and/or a Bluetooth signal.

According to some aspects of the disclosure, the power source is a battery in the wireless device.

According to some aspects of the disclosure, the wireless device comprises at least one water sensor positioned on the outer surface of the wireless device and wherein the step of detecting that the wireless device is submerged in water further comprises detecting, using the water sensor, that water is present.

According to some aspects of the disclosure, it provides for a computer program, comprising computer readable code which, when run on a wireless device, causes the wireless device to perform the method according to above.

With the above description in mind, aspects of the present disclosure overcome at least some of the disadvantages of known technology as previously described.

### BRIEF DESCRIPTION OF THE DRAWINGS

The present invention will be more readily understood through the study of the following detailed description of the embodiments/aspects together with the accompanying drawings, of which:

FIG. 1 illustrates an example of a waterproof wireless device.

FIG. 2 illustrates another example of a waterproof wireless device.

FIG. 3 illustrates yet another example of a waterproof wireless device.

FIG. 4 is a flow chart illustrating the proposed method, performed in the wireless device.

FIG. 5 illustrates an example of a waterproof wireless device submerged in water.

FIG. 6 illustrates another example of a waterproof wireless device in the form of a wearable device submerged in water on the wrist of a diver.

### DETAILED DESCRIPTION

Aspects of the present disclosure will be described more fully hereinafter with reference to the accompanying drawings. The method and device disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

The term wearable and wearable device are used interchangeably and is referring to a wireless device which is worn somewhere on the body of a user. Examples of wearables are watches, wristbands, headsets, headbands, etc.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

As used herein, the term “wireless device” includes portable communication device, portable radio communication equipment and wearables. A portable communication device or a portable radio communication device may be referred to below as a smartphone and includes all electronic equipment, including, but not limited to, capable of being used for voice and/or data communication. As will be appreciated, the disclosure may be used with mobile phones, other phones, smartphones, personal digital assistants (PDAs), computers, other communication devices, etc. For brevity, the disclosure will be described by way of examples with respect to smartphones, but it will be appreciated that the disclosure may be used with other communication devices.

The proposed technology is generally applicable to any wireless communication device but by the nature of the disclosure it is preferred that the wireless device is waterproof, with an IP class of at least 7 with regards to Liquid ingress protection or corresponding.

The present disclosure propose a method performed in a wireless device 1, comprising communication circuitry 2 for wireless communication, of reducing power consumption. Furthermore, a wireless device is provided which performs the method.

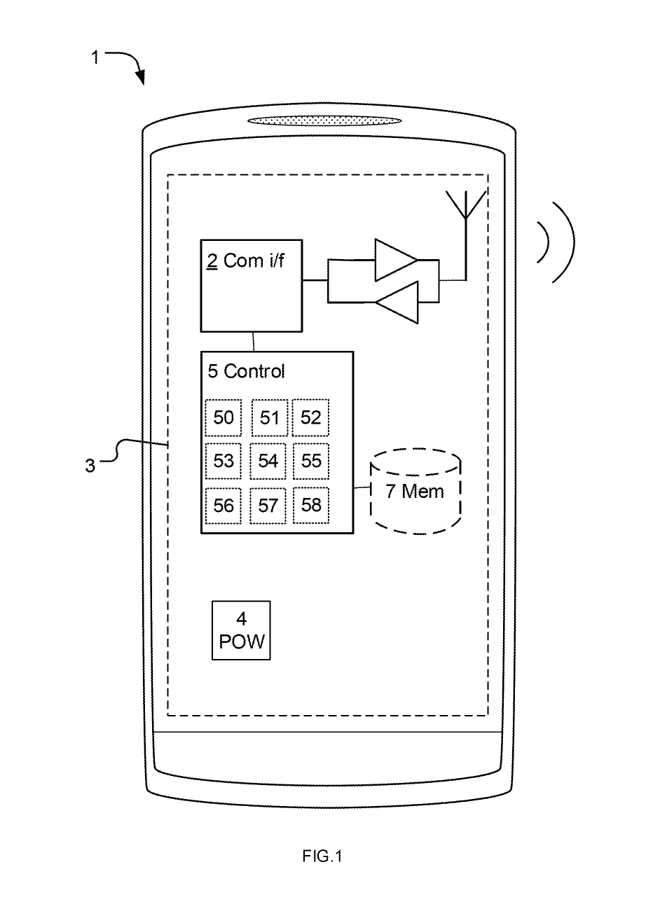

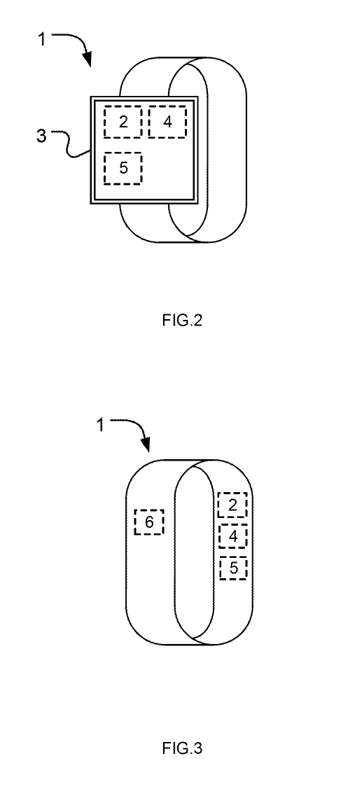

FIGS. 1, 2 and 3 illustrates two examples of wireless devices 1. In FIG. 1 the wireless device is illustrated as a mobile communication device, such as a smartphone, and in FIG. 2 the wireless device is illustrated as a wearable device, such as a watch. The wireless device 1 comprises communication circuitry 2 for wireless communication, a power source 4 for supplying power to the communication circuitry and processing circuitry 5. According to some aspects, the wireless device comprises a touch screen 3; that is not the case if the wireless device is a type of wearable without a touch screen such as a wristband, see FIG. 3. According to some aspects the wireless device comprises at least one water sensor 6.

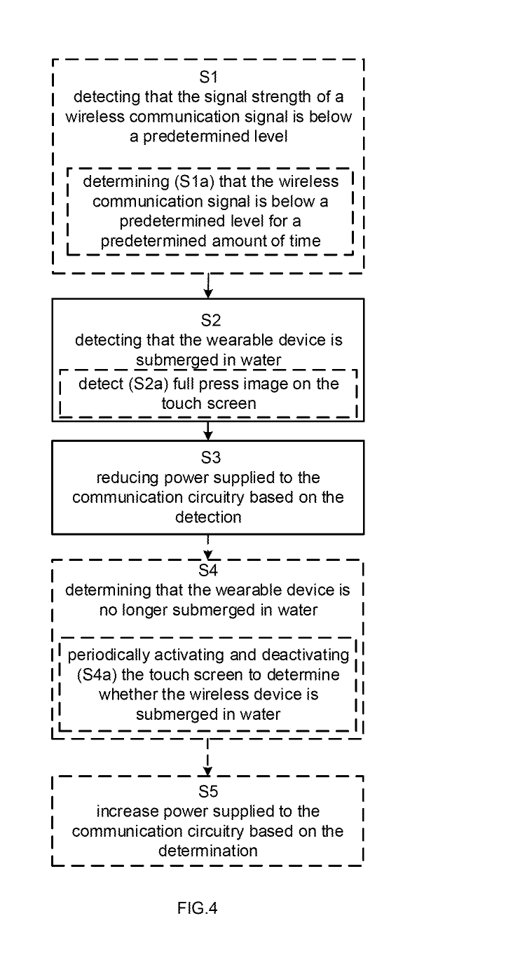

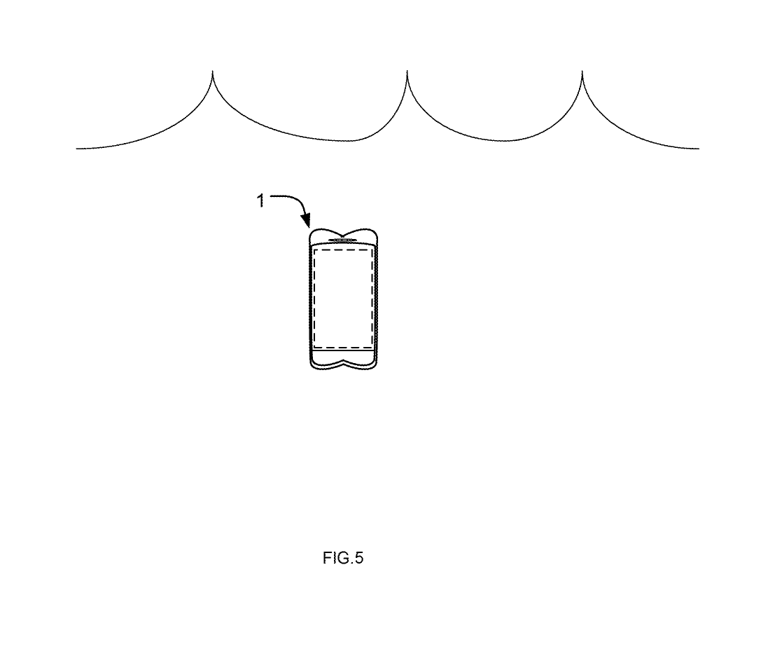

FIG. 4 is a flow diagram depicting example operations which may be taken by the wireless device of FIGS. 1 and 2.

It should be appreciated that FIG. 4 comprise some operations which are illustrated with a solid border and some operations which are illustrated with a dashed border. The operations which are comprised in a solid border are operations which are comprised in the broadest example embodiment. The operations which are comprised in a dashed line are example embodiments which may be comprised in, or a part of, or are further operations which may be taken in addition to the operations of the broader example embodiments. It should be appreciated that the operations need not be performed in order. Furthermore, it should be appreciated that not all of the operations need to be performed.

The proposed technique will now be briefly described referring to FIGS. 1, 2, 3 and 4. As previously discussed, the disclosure provides for a method of reducing power consumption in a wireless device.

The method comprises the steps of detecting S2 that at least a part of the wireless device 1 is submerged in water and reducing S3 power supplied to the communication circuitry 2 based on the detection. The processing circuitry 5 is configured to detect S2 that the wireless device 1 is submerged in water and to reduce S3 power supplied to the communication circuitry based on the detection. According to some aspects the processing circuitry comprises a detector 50 for detection and a reducer 51 for reducing the power. Thus, when detecting that the wireless device is submerged in water, or at least that the parts of the wireless device that comprises means for detecting that the device is submerged are submerged in water, i.e. a situation where wireless communication using radio does not work, the power to the communication circuitry is reduced or even turned off to save battery in the device. According to some aspects, reducing the power to the communication circuitry means setting the power output of all radio transmitters of the wireless device to zero and not checking for incoming signals. According to some aspects, reducing the power to the communication circuitry means that all Application Specific Integrated Circuits, ASICs, associated with connection to a mobile network, using GPS, using Bluetooth and/or using WiFi are powered off or the power to the ASICs is reduced. All amplifiers associated with said communication circuitry are also turned off or their power is reduced. Hence, according to some aspects, the wireless communication signals are radio signals.

It should be noted that there are types of radio communication that work in water. For example communication technologies using Very Low Frequencies, VLF, which can penetrate seawater approximately 20 meters and Extremely Low Frequencies, ELF, which can penetrate hundreds of meters. In a wireless device having communication circuitry adapted to utilize such a technology the communication circuitry which is used for under water communication will not be turned off. There are other technologies that will work as communication means under water, such as sonar technologies, and if a wireless device is equipped with such technology the communication circuitry for that technology will off course not be powered off under water. Body Coupled Communication, BCC, is another technology which may function under water. BCC uses conductive tissues in the body as a channel to form a body area network, thus wirelessly connecting devices and wearables which are in close proximity to the user's body. Using BCC under water is possible but the settings of BBC parameters may be different than when BCC is used in air. The parameters need to be changed for example due to differences in pressure and reflection. According to some aspects of the disclosure, the BCC parameters are adapted so that it functions under water when it is detected that the wireless device is submerged in water according to above.

According to some aspects, the method further comprises the step of detecting S1 that the signal strength of a wireless communication signal is below a predetermined level. The processing circuit 4 is configured to detect S1 that the signal strength of the wireless communication signal is below a predetermined level. According to some aspects the processing circuitry comprises a second detector 52 for the detection. When a wireless device is submerged in water all wireless radio communication signals are lost. This is used as a good indication that the wireless device is submerged and the wireless device checks if the device is submerged after detection of that the signal strength is below a predetermined level. In other words, when a wireless device is submerged the wireless communication signal strength is virtually zero. Different wireless devices have different capabilities to receive signals so that one signal which is receivable in one wireless device might not be so in another even though they are at the same location. The capability depends on for example the antenna design of the wireless device. All wireless devices have a predetermined signal strength level under which the device deems the signal to be lost. In other words, the predetermined level is different for different wireless devices. The predetermined level is the level of which the wireless device deems the signal to be lost, wherein the wireless device comprises default settings of at what level of signal strength the signal is lost. According to some aspect the signal strength is measured in decibel milliwatt, dBm.

A regular procedure for a wireless device which loses radio signal is to start scanning for signals and searching for base stations and receivers and in many cases the output power will be raised. A raised output power will result in a shorter battery time for the wireless device. Communication circuitry running on full power might consume up towards 600 mA which would mean that a 300 mAh battery would go from 100% to 0% charge in 30 minutes. Using the described method will prevent this wasted use of power in the wireless device.

According to some aspects, the step of detecting (S1) that the signal strength of a wireless communication signal is below a predetermined level further comprises determining (S1a) that the wireless communication signal is below a predetermined level for a predetermined amount of time. According to some aspects the processing circuitry 4 is configured to determine that the wireless communication signal is below a predetermined level for a predetermined amount of time. According to some aspects the processing circuitry comprises a determiner 53 for determination. An advantage of this is that if a wireless device is for example just dropped in water and then picked up right away, the power supplied to the communication circuitry does not need to be reduced. Another example is when a user of the wireless device just washes the device quickly in water; then the communication circuitry may stay active. The predetermined amount of time is for example 1 second. According to some aspects the predetermined amount of time is between 0.01 seconds and 3 minutes. According to some aspects the predetermined amount of time is between 0.1 seconds and 1 minute. According to some aspects the predetermined amount of time is between 0.2 seconds and 10 seconds.

According to some aspects, the wireless communication signal comprises any of, or several of: a GPS signal, a network signal, a WiFi signal, a Bluetooth signal. In other words, according to some aspects the communication circuitry comprises radio communication circuitry. In other words, the wireless device comprises communication circuitry for communication using for example a 3GPP LTE signal, a WCDMA signal, a WiMax signal, an UMB signal, a GSM or UMTS signal.

According to some aspects, the method further comprises the steps of determining S4 that the wireless device is no longer submerged in water and increasing S5 power supplied to the communication circuitry based on the determination. According to some aspects the processing circuit 4 is configured to determine S4 that the wireless device is no longer submerged in water and to increase S5 power supplied to the communication circuitry based on the determination. According to some aspects the processing circuitry comprises a second determiner 54 for determination and an increaser 55 for increasing the power. In other words, when the wireless device has determined that it is no longer submerged in water it activates the communication circuitry.

According to some aspects, the step of reducing S3 power supplied to the communication circuitry comprises at least one of: disabling transmission of signals and/or disabling reception of signals. Thus, the communication circuitry is disabled. As previously discussed, there might be a wireless device with communication means to communicate under water and in that case the specific circuitry for that communication means will stay active.

According to some aspects, the wireless device 1 further comprises a capacitive touch screen 3 and wherein the step of detecting S2 that the wireless device is submerged in water further comprises detecting S2a that the touch screen is saturated. According to some aspects the processing circuit 4 is configured to detect that the touch screen is saturated. According to some aspects, the processing circuitry comprises a third detector 56 for detecting. When a touch screen is saturated it can be assumed that the whole screen is covered or submerged in water, or another liquid with suitable conductivity, no other method of touching or pressing of the screen gives full saturation; it is for example impossible to achieve by using hands. A saturated touch screen is a screen with 100% press image, i.e. that every part of the screen is pressed. A touch screen comprises a number of nodes, for example 10×20, comprising capacitors and when a user touches the screen the capacitance from the capacitors on the touched nodes is discharged. A saturated touch screen is when all capacitors in the touch screen are discharged, which in reality only happens when the screen is touched on the entire surface, i.e. 100% pressed. In other words, that the touch screen is saturated means that the surface of the touch screen is pressed/touched at 100% of the surface by something conductive. There are touch screens which are a combination of pressure sensitive, i.e. resistive touch screens and capacitive touch screens, in such a case users will be able to use the screens under water with the pressure sensitive technology whereas the capacitive parts will be saturated. In such a case the communication circuitry will still be disabled but all other parts of the wireless device will function normally. Note that there might be other types of screens that will work within the scope of this disclosure, for example an infrared grid screen. All types of screens that give a 100% press image when the wireless device is submerged may be used to detect submersion of the device which induces deactivation of communication circuitry.

According to some aspects, the step of determining S4 that the wireless device is no longer submerged in water further comprises periodically activating and deactivating S4a the touch screen to determine whether the wireless device is submerged in water. According to some aspects, the processing circuit 4 periodically activates and deactivates the touch screen. According to some aspects, the processing circuitry comprises an activator 57 and a deactivator 58 for the periodical activation and deactivation. Note that there is no need to light up the display when using it to detect if the wireless device is still submerged; only the touch sensitive circuitry needs to be activated. This is an effective way of checking that the wireless device is still submerged in water without activating the communication circuitry. Periodically means that the screen is activated and deactivated in certain time intervals. The time between activation and deactivation is just time long enough for the wireless device to detect if the device is submerged or not. The time between two activations of the touch screen is any time between 1 millisecond and 10 minutes. According to some aspects, the time between to activations is any time between 1 millisecond and 5 minutes. According to some aspects, the time between to activations is any time between 1 millisecond and 3 minutes. According to some aspects, the time between to activations is any time between 1 millisecond and 1 minute. According to some aspects, the time between to activations is any time between 1 millisecond and 30 seconds. According to some aspects, the time between to activations is any time between 1 millisecond and 10 seconds. Periodically activating and deactivating the touch screen to check if the wireless device is still submerged in water has a much smaller energy impact than continuously scanning for networks.

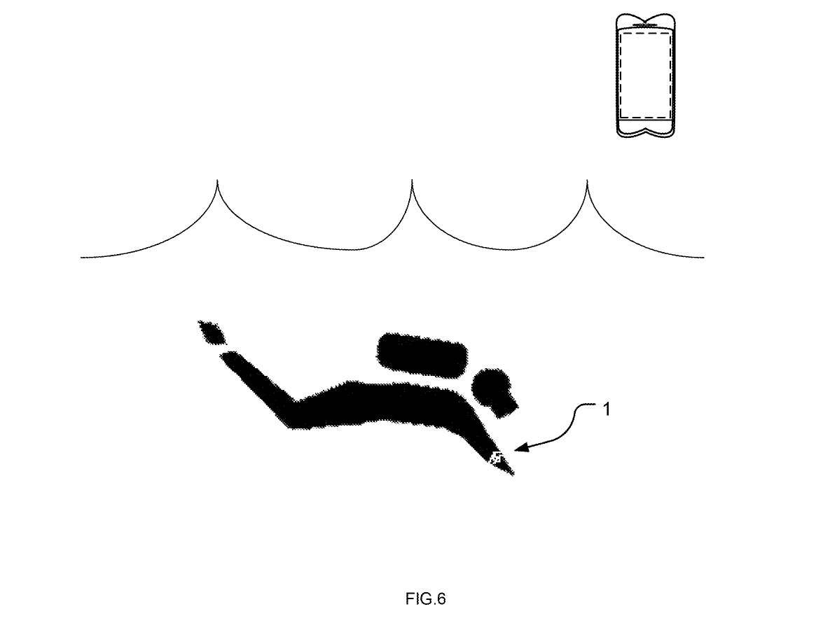

Examples of the above described method in use can be seen in FIGS. 5 and 6. According to some aspects, the wireless device is a wearable wireless device or a mobile communication device. FIG. 5 illustrates a case where the wireless device is a smartphone which is submerged in water. Another example is illustrated in FIG. 6 and is when a user of a wireless device 1, in the form of a wearable smartwatch, goes diving with the watch on. The smartwatch is connected to a smartphone via Bluetooth. The smartwatch detects that the Bluetooth signal has been lost for a number of seconds, for example 5, and activates the touch screen and detects that the screen is saturated. The smartwatch then turns off power to the communication circuits; thus disabling Bluetooth. The smartwatch then periodically activates and deactivates the touchscreen to determine whether it is still submerged. As soon as the smartwatch activates the touch screen when the user has left the water, the communication circuitry will be powered on, thus activating Bluetooth.

According to some aspects, the wireless device comprises at least one water sensor positioned on the outer surface of the wireless device and wherein the step of detecting that the wireless device is submerged in water further comprises detecting, using the water sensor, that water is present. In other words, the wireless device may use water sensors instead of a touch screen to detect submersion. This is especially useful when the wireless device is a device without a touch screen, for example a wristband or a headset. A wireless device comprising both a touch screen and one or several water sensors may use either the touch screen or the water sensor or a combination of both to detect submersion of the device. A water sensor is for example two electrodes and sensor circuitry connected to the electrodes. The sensor circuitry detects if there is current between the electrodes, i.e. if there is a conductive liquid connecting the electrodes. In such a case the electrodes are positioned on the outer surface of the device and are connected to circuitry on the inside of the shell of the device. Any type of water sensors which can detect presence of water may be used. If the electrodes are such that they need to be positioned closely together, for example 1 centimeter apart or less, to be able to detect the current between them, there will be two such of water sensors on the wireless device at different positions so that the wireless device may detect presence of water at two positions. The wireless device can then detect if the device is submerged and not just wet. When the wireless device is a smartwatch or a wristband, there are for example two water sensors which are located on the surface facing away from the wrist of the user and on opposite sides of the wrist. If both water sensors indicate that water is present the wireless device reduces power to its communication circuitry according to above. A wristband often communicates with a connected smartphone using Bluetooth and in those cases the Bluetooth is deactivated when water is detected at the water sensors.

According to some aspects, the power source 4 is a battery in the wireless device. The power source is a positioned in the device. According to some aspects the wireless device is a self-sustaining device which uses energy harvesting such as solar cells for power.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of method steps or processes, which may be implemented according to some aspects by a computer program, comprising computer readable code which, when run on a wireless device, causes the wireless device to perform the method according to above. The computer program, embodied in a computer-readable medium, includes computer-executable instructions, such as program code, executed by computers in networked environments. A computer-readable medium may include removable and non-removable storage devices 7 including, but not limited to, Read Only Memory, ROM, Random Access Memory, RAM, compact discs, CDs, digital versatile discs, DVD, etc. Generally, program modules may include routines, programs, objects, components, data structures, etc. that performs particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A method, performed in a wireless device comprising communication circuitry for wireless communication, of reducing power consumption, the method comprising:
detecting that at least a part of the wireless device is submerged in water; and
reducing power supplied to the communication circuitry based on the detection.

2. The method according to claim 1, further comprising:
detecting that the signal strength of a wireless communication signal is below a predetermined level.

3. The method according to claim 2, wherein the step of detecting that the signal strength of a wireless communication signal is below a predetermined level further comprises determining that the wireless communication signal is below a predetermined level for a predetermined amount of time.

4. The method according to claim 2, wherein the wireless communication signal comprises at least one of: a GPS signal, a network signal, a WiFi signal, or a Bluetooth signal.

5. The method according to claim 1, further comprising:
determining that the wireless device is no longer submerged in water; and
increasing power supplied to the communication circuitry based on the determination.

6. The method according to claim 1, wherein the step of reducing power supplied to the communication circuitry comprises at least one of: disabling transmission of signals or disabling reception of signals.

7. The method according to claim 1, wherein the wireless device further comprises a capacitive touch screen and wherein the step of detecting that the wireless device is submerged in water further comprises detecting that the touch screen is saturated.

8. The method according to claim 7, wherein the step of determining that the wireless device is no longer submerged in water further comprises periodically activating and deactivating the touch screen to determine whether the wireless device is submerged in water.

9. The method according to claim 1, wherein the wireless device further comprises at least one water sensor positioned on the outer surface of the wireless device and wherein the step of detecting that the wireless device is submerged in water further comprises detecting, using the water sensor, that water is present.

10. The method according to claim 1, wherein the wireless device is a wearable wireless device or a mobile communication device.

11. A wireless device comprising:
communication circuitry for wireless communication;
a power source for supplying power to the communication circuitry;
processing circuitry configured to:
detect that the wireless device is submerged in water; and
reduce power supplied to the communication circuitry based on the detection.

12. The wireless device according to claim 11, wherein the processing circuitry is further configured to:
detect that the signal strength of a wireless communication signal is below a predetermined level.

13. The wireless device according to claim 11, wherein the processing circuitry is further configured to:
determine that the wireless device is no longer submerged in water; and increase power supplied to the communication circuitry based on the determination.

14. The wireless device according to claim 11, wherein the communication circuitry comprises radio communication circuitry.

15. The wireless device according to claim 11, wherein the power source is a battery in the wireless device.

16. The wireless device according to claim 11, wherein the wireless device further comprises at least one water sensor positioned on the outer surface of the wireless device and wherein the step of detecting that the wireless device is submerged in water further comprises detecting, using the water sensor, that water is present.

17. A computer program, comprising computer readable code which, when run on a wireless device, causes the wireless device to perform the method as claimed in claim 1.
